(19) United States
(12) Patent Application Publication
(10) Pub. No.: US 2005/0077807 A1
(43) Pub. Date: Apr. 14, 2005

(54) Method-for producing a spark plug, and spark plug

(75) Inventors: Akira Suzuki, Kasugai-shi (JP); Wataru Matsutani, Nagoya-shi (JP)

Correspondence Address: SUGHRUE MION, PLLC, 2100 PENNSYLVANIA AVENUE, N.W., SUITE 800, WASHINGTON, DC, 20037, US

(73) Assignee: NGK SPARK PLUG CO., LTD.

(21) Appl. No.: 10/948,465

(22) Filed: Sep. 24, 2004

Related U.S. Application Data
(60) Provisional application No. 60/603,270, filed on Aug. 23, 2004.

(30) Foreign Application Priority Data
Sep. 27, 2003 (JP) P. 2003-373436

(51) Int. Cl. H01T 13/20

(52) U.S. Cl. 313/141

(57) ABSTRACT

[Problem]A production method is provided that can improve the reliability of a molten bond of a spark plug in which a small-diameter noble metal tip is laser welded while protruding from a side face of a ground electrode. [Means for Resolution]

A discharge portion 52 which forms a discharge gap 6 between the portion and a tip end face 51 of a center electrode 3 is configured by: forming a taper 4b in a ground electrode 4, the width of the taper being smaller as advancing toward the tip end so as to attain a diameter of 0.8 mm or less and a height of 0.5 mm or more; and then bonding the portion by laser welding to a side face 4a of the ground electrode 4.

### TECHNICAL FIELD

The present invention relates to a method of producing a spark plug, and also to a spark plug.

### BACKGROUND ART

JP-A-2002-237365 discloses in FIG. 26 a ground electrode in which a noble metal tip is laser-welded to a side face that is formed into a tapered shape as advancing toward the tip end side, so as to protrude from the side face.

[Patent Reference 1] JP-A-2002-237365

[Disclosure of the Invention]

[Problems that the Invention is to Solve]

When the formation of the ground electrode into a tapered shape is conducted after the noble metal tip is laser welded, an impact occurring during the formation of a tapered shape may cause a crack or the like in a molten bond formed by the welding. Particularly, this phenomenon highly tends to occur when the laser welding is conducted in a state where, in order to improve the ignitability, a noble metal tip having a small diameter of 0.8 mm or less protrudes by 0.5 mm or more from the side face of the ground electrode.

The invention has been conducted in view of the problem. It is an object of the invention to provide a method of producing a spark plug in which the reliability of a molten bond can be improved.

[Means for Solving the Problems]

The method of producing a spark plug of the invention is a method of producing a spark plug having: a center electrode; an insulator which covers a circumference of the center electrode in a state where a tip end portion of the center electrode protrudes; a metal shell which holds the insulator; a ground electrode which is fixed to the metal shell, the ground electrode having a side face in which a width is smaller as advancing toward a tip end side, thereby forming a taper; and a discharge portion which is bonded to the ground electrode by laser welding to attain a diameter of 0.8 mm or less and a height of 0.5 mm or more, a discharge gap being formed between the discharge portion and the tip end portion of the center electrode, wherein the taper is formed before the discharge portion is laser-welded to the side face.

In the case of a diameter of 0.8 mm or less in which a molten bond has a small sectional area, the weld strength is easily reduced. In the case where the protrusion distance of the noble metal tip is 0.5 mm or more, moreover, stresses due to vibrations in the process of forming the taper tend to be easily concentrated in the molten bond. By contrast, when a spark plug is produced by the method of the invention, it is possible to solve the problem.

Preferably, the laser welding is conducted after the noble metal tip consisting primarily of a noble metal is placed so that the minimum distance between either of the taper and the tip end face of the ground electrode, and the noble metal tip is set to be 0.1 mm or more and 0.8 mm or less.

In the laser welding of the noble metal tip, when the irradiation angel of a laser beam is about ±20° with respect to an extension face of the side face of the ground electrode to which the discharge portion is to be bonded, the laser welding can be stably conducted. During a laser welding process, although both the discharge portion and the ground electrode must be simultaneously melted, the laser beam can be focused on a range of about 0.8 mm or less. Nickel which is the principal component of the ground electrode base member is more easily melted than the noble metal tip consisting primarily of a noble metal. Because of these reasons, when laser welding is conducted after placement of the discharge portion as in the invention, the laser welding can be stably conducted.

In order to prevent a spark to the molten bond, preferably, the distance between the tip end face of the noble metal tip and the molten bond is set to be larger, or specifically the height (t) of the unmelted portion in the noble metal tip is set to be 0.3 mm or more. A spark plug in which the height of the unmelted portion is large in this way tends to be easily broken because of stress concentration due to vibrations in the process of forming the taper. When the laser welding is conducted after the taper is formed, it is possible to avoid the stress concentration from occurring.

The height (t) of the unmelted portion is defined by the minimum distance between the tip end face of the noble metal tip and the molten bond.

Preferably, the molten bond is formed to extend from the side face to the taper, and has a curved shape which has a radius of curvature in an edge formed by the side face and the taper. When the edge formed at a corner between the side face and the taper is angular, the electric field is easily concentrated in the portion. As a result, in such a structure, a spark to the molten bond easily occurs, and hence the molten bond is susceptible to be damaged. By contrast, when the edge formed by the side face of the ground electrode and the taper is melted during the laser welding and the molten bond is formed into a curved shape which has a radius of curvature in the edge formed by the side face and the taper, a damage of the molten bond due to a concentration of electric field can be effectively prevented from occurring.

Preferably, a spark plug in which the molten bond can be effectively prevented from being damaged both during a production process and after the production process is a spark plug having: a center electrode; an insulator which covers a circumference of the center electrode in a state where a tip end portion of the center electrode protrudes; a metal shell which holds the insulator; a ground electrode which is fixed to the metal shell, the ground electrode having a side face in which a width is smaller as advancing toward a tip end side, thereby forming a taper; and a discharge portion in which a noble metal tip is bonded to the ground electrode by laser welding to attain a diameter of 0.8 mm or less and a height of 0.5 mm or more, a discharge gap being formed between the discharge portion and the tip end portion of the center electrode, wherein a molten bond in which the noble metal tip and the ground electrode are melted together is formed to extend from the side face to the taper, the molten bond having a curved shape which has a radius of curvature in an edge formed by the side face and the taper.

Preferred examples of a material of the noble metal tip are Pt alloys such as Pt-20 wt % Ni, Pt-20 wt % Rh, and Pt-20 wt % Rh-5 wt % Ni, and Ir alloys such as Ir-5 wt % Pt, Ir-20 wt % Rh, Ir-5 wt % Pt-1 wt % Rh-1 wt % Ni, and Ir-11 Ru-8 wt % Rh-1 wt % Ni. The material is not restricted to the example, and other known noble metal tips can be adequately applied.

[Best Mode for Carrying Out the Invention]

Hereinafter, a method of producing a spark plug which is a preferred embodiment of the invention will be described.

FIG. 1 shows a spark plug which is produced by the production method of the embodiment. As shown in FIG. 1, the spark plug has a cylindrical metal shell 1. The metal shell 1 comprises a fitting thread portion 1a for fixing the spark plug to an engine block which is not shown. An insulator 2 which is made of alumina ceramic (Al₂O₃) or the like is fixed to the inside of the metal shell 1. A center electrode 3 is fixed to an axial hole 2a of the insulator 2. A tip end portion 2b of the insulator 2 is disposed so as to be exposed from the metal shell 1.

The center electrode 3 is a columnar member in which a metal material having an excellent thermal conductivity, such as Cu is placed inside the electrode, and another metal material that is excellent in thermal resistance and corrosion resistance, such as a nickel-base alloy consisting of INCONEL 600 (trademark) covers the outside of the metal material having an excellent thermal conductivity. A tip end portion 51 of the center electrode is disposed so as to be exposed from the tip end portion 2b of the insulator 2. The tip end portion 51 is formed by a noble metal tip made of an iridium alloy. The tip end portion 51 is formed into a circular shape in section. In consideration of the heat dissipation property of the tip end portion 51 and the flame quenching effect of the center electrode 3, for example, the tip end portion 51 has a diameter of 0.6 mm and a length of 0.8 mm.

The center electrode 3 has as a small-diameter portion 3c at the tip end side, and has a straight portion in the tip end of the small-diameter portion 3c. A noble metal tip made of 95 wt % of iridium and 5 wt % of platinum is placed on the tip end of the straight portion, and then bonded by laser welding, thereby forming the tip end portion 51. The outer diameter of the straight portion is slightly larger than that of the noble metal tip. The laser welding is conducted at eight spots of an outer periphery of the noble metal tip which are arranged at intervals of 45° in the circumferential direction.

A ground electrode 4 is fixed by welding to one end of the metal shell 1. The ground electrode 4 is made of a metal material such as a nickel-base alloy consisting of INCONEL 600 (trademark), and has a side face (a face opposed to the center electrode) 4a which is tapered so that the width is smaller as advancing toward the tip end. A noble metal tip 52a consisting primarily of a noble metal is bonded to the side face 4a by laser welding so as to protrude by about 0.8 mm from the side face 4a, thereby forming a discharge portion 52. A discharge gap 6 is formed by the discharge portion 52 and the tip end portion 51 of the center electrode 3. The discharge portion 52 has a circular section shape having a diameter of 0.7 mm, and is formed by an alloy of 80 wt % of platinum and 20 wt % of iridium. Usually, the ground electrode 4 is formed so as to have a width of about 2.2 to 2.8 mm, and the tip end face of the taper is formed so as to have a width of about 0.6 to 1.2 mm. In the specification, “consisting primarily of a noble metal” means that the content of a noble metal(s) is larger than 50%.

The wear amount due to spark discharge is larger in the tip end portion 51 of the center electrode 3 than in the discharge portion 52 of the ground electrode 4. The ground electrode 4 is more easily raised in temperature than the center electrode 3. In the embodiment, therefore, the tip end portion 51 is made of an iridium alloy which exerts a higher wear resistance against spark discharge, and the discharge portion 52 is made of a platinum alloy in which oxidation and volatilization do not occur at a high temperature.

Next, a method of producing the spark plug 1 will be specifically described with reference to FIG. 2. A substantially cylindrical metal shell 1′ which has not yet been subjected to a threading process is formed by processes such as a cold extrusion process and a cutting process. In the metal shell 1′, a tool engagement portion 1d having a hexagonal section shape is formed on one end side with respect to an axial middle portion 1b, and a thread forming portion 1a′ which has a substantially cylindrical, and in which the diameter is smaller than that of the center portion 1b is formed on the other end side (see FIG. 2A).

The ground electrode 4 having the taper 4b formed in the tip end is resistance-welded to a tip end face 1e of the thread forming portion 1a′ (see FIG. 2B). Then, a rolling process is applied to the thread forming portion 1a′ of the metal shell 1′ to form the fitting thread portion 1a (FIG. 2C). Next, a surface treatment such as galvanizing is applied to the metal shell 1′, and the insulator 2 holding the center electrode 3 to which the noble metal alloy tip is welded to form the tip end portion 51 is attached to the metal shell 1′ (FIG. 2D). The noble metal tip 52a is placed in a portion of the side face 4a in which the width is made smaller than the original width of the ground electrode by the formation of the taper 4b. The contact face between the side face 4a and the noble metal tip 52a is irradiated with a laser beam in a substantially horizontal direction, thereby forming the discharge portion 52 in the ground electrode 3 (FIG. 2E).

In the embodiment, the ground electrode 4 in which the taper is previously formed is resistance-welded to the ground electrode 4. Alternatively, the taper may be formed after the resistance welding is conducted. Alternatively, the discharge portion 52 may be formed by provisionally welding the noble metal tip 52a on the side of the ground electrode to the side face 4a of the ground electrode 4 by resistance welding or the like, forming the taper, and thereafter conducting laser welding. In other words, the taper may be formed in the ground electrode 4 in any step as far as the laser welding has not yet been conducted.

### EXAMPLES

In order to clarify further preferable placements of the discharge portion 52 in the above-described preferred embodiment of the invention, the placements will be described with reference to FIGS. 3 to 5.

FIG. 3 is a diagram showing a placement of the discharge portion 52 with respect to the side face 4a of the ground electrode 4 in the invention, i.e., the minimum distance L between the taper 4b and the tip end face 4c of the ground electrode 4, and the noble metal alloy tip 52a. FIG. 4 shows results of ascertainments of the weldability in the case where the minimum distance L was set to have a value of 0 to 1.0 mm. The weldability was evaluated in the following manner. A spark plug is repeatedly subjected to 1,000 cycles in each of which the tip end of the spark plug on the side of the spark discharge gap is heated by a gas burner for two minutes to 1,000° C. in the vicinity of the molten bond between the ground electrode 4 and the noble metal tip 52a, and then air cooled for one minute (this corresponds to a travel distance of about 100,000 km in a durability test on an actual engine under usual traveling conditions). Then, the spark plug which has undergone the test is cut and polished in a plane passing the center axis of the discharge portion 52, and the section is magnified and observed under a microscope. The development length of oxidized scale in the interface between the noble metal tip 52a and the ground electrode 4 is measured in the observation field. The measured length is divided by the total length of the interface, and the division result is set as an oxidized scale development rate. A spark plug in which the oxidized scale development rate is larger than 50% was judged that the weldability is not good (×), that in which the rate is 30 to 50% was judged that the peel resistance is good (◯), and that in which the rate is,smaller than 30% was judged as excellent (\mathring{∘}).

From the results, it is seen that satisfactory results were obtained when L is 0.1 to 0.8 mm, and the best results were obtained when L is 0.3 to 0.5 mm. FIG. 5 is a diagram showing a state after laser welding in the case where the discharge portion 52 is formed by placing the noble metal tip 52a on the side face 4a of the ground electrode 4 so as to attain the value of L at which the best result is obtained. FIG. 5B is a partial section view taken along the line A-A′ in FIG. 5A. As shown in FIG. 5B, a molten bond 53 is formed so as to extend from the side face 4a to the taper 4b, and has a curved shape which protrudes outward in a convex shape, and which has a radius of curvature R, in an edge formed by the side face 4a and the taper 4b.

In the noble metal tip 52a, a portion (unmelted portion) which is not melted by the laser welding has a height t of 0.45 mm. The minimum distance (the height t of the unmelted portion) between the tip end face of the noble metal tip 52a and the molten bond 53 is set to be 0.3 mm or more. In the resulting structure, therefore, discharge to the molten bond hardly occurs.

### BRIEF DESCRIPTION OF THE DRAWINGS

FIG. 1 is a front view showing an embodiment of a spark plug which is produced by the method of producing a spark plug of the invention.

FIGS. 2A to 2E are views diagrammatically showing steps of producing the spark plug of the invention.

FIG. 3 is a diagram showing a placement of a discharge portion, or the minimum distance L between a taper portion and a tip end portion of a ground electrode, and the discharge portion.

FIG. 4 is a view showing results of ascertainments of the weldability in the case where the minimum distance L was set to have a value of 0 to 1.0 mm.

FIGS. 5A and 5B are diagrams showing a state after laser welding in the case where the discharge portion is placed so-as to attain the value of L at which an excellent result is obtained.

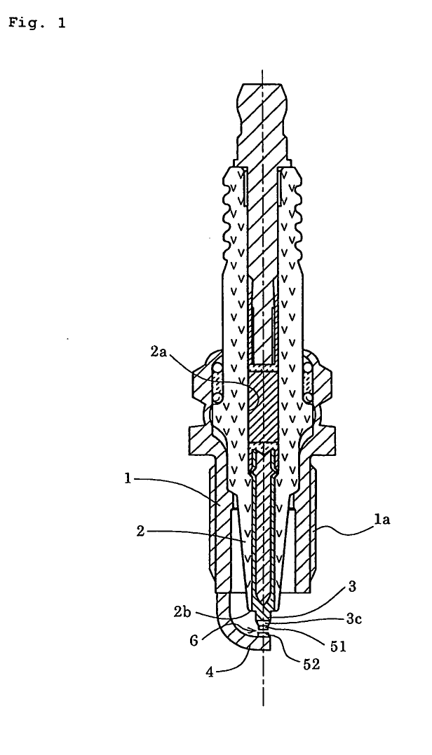

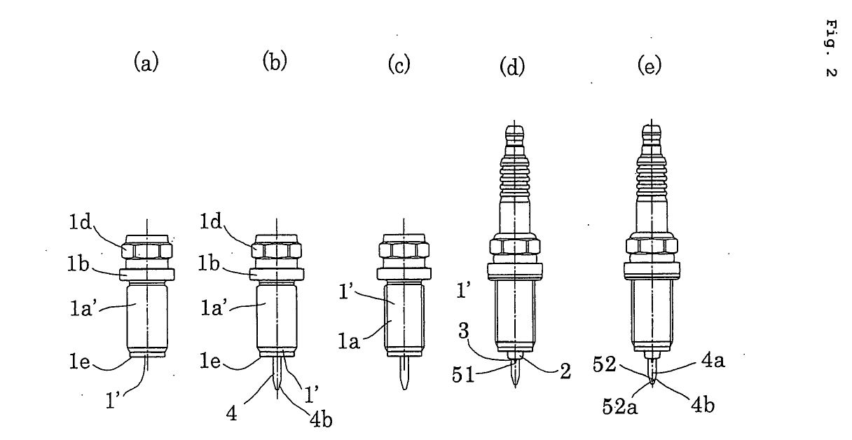

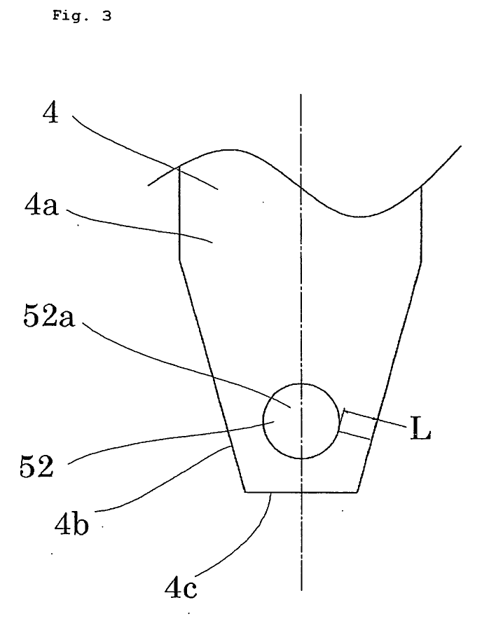

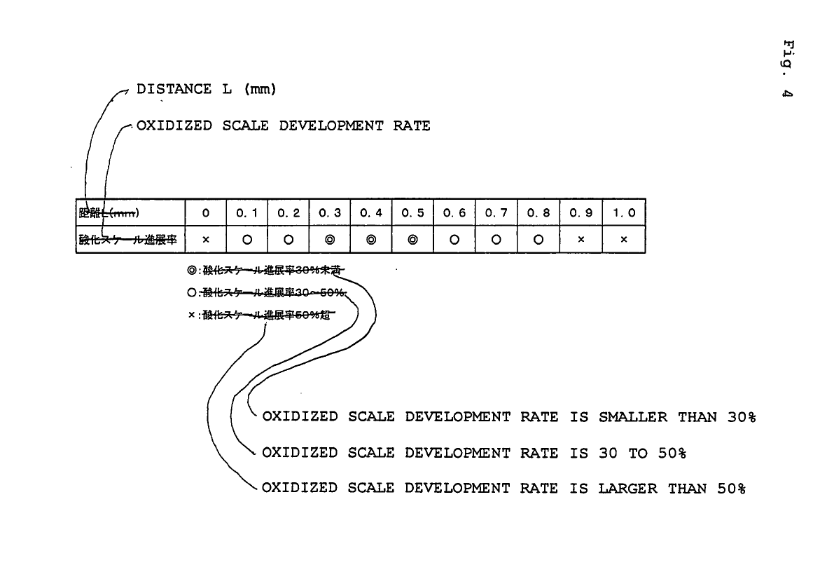

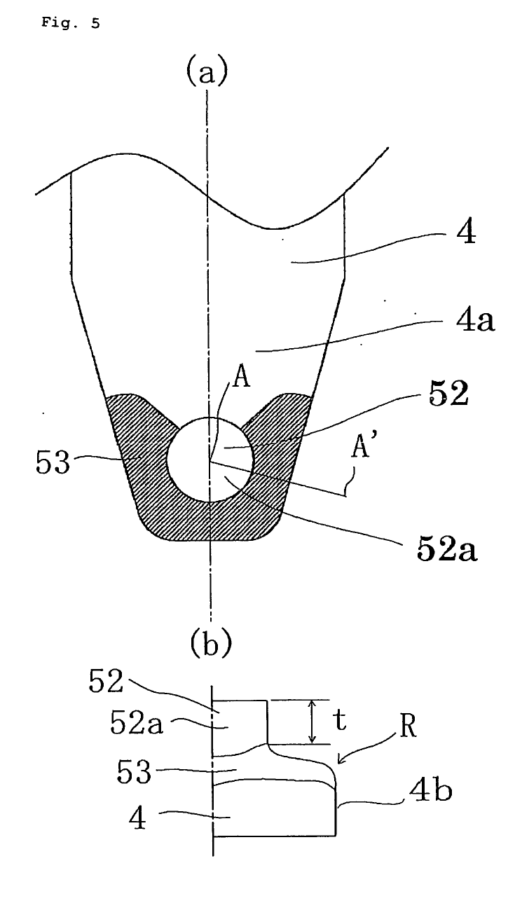

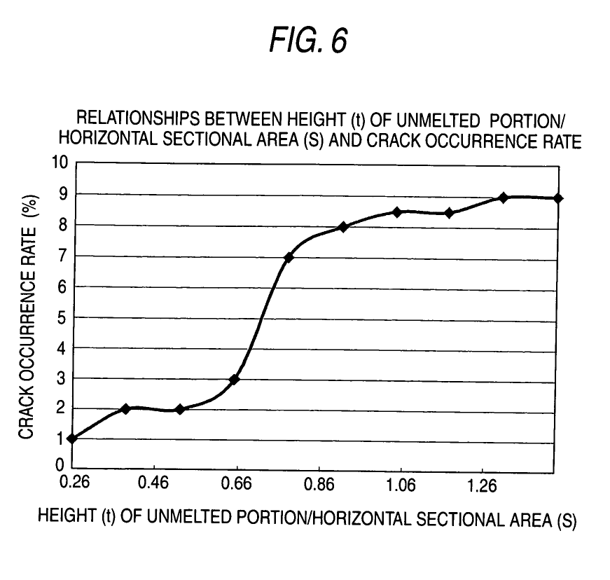

### DESCRIPTION OF REFERENCE NUMERALS AND SIGNS

1 metal shell
1a thread portion
2 insulator
3 center electrode
3a tip end face
4 ground electrode
4a side face
4b tapered face
4c tip end face
51 tip end portion
52 discharge portion
52a noble metal tip
53 molten bond
6 discharge gap

1. A method of producing a spark plug having:
a center electrode (3);
an insulator (2) which covers a circumference of said center electrode (3) in a state where a tip end portion (51) of said center electrode (3) protrudes;
a metal shell (1) which holds said insulator (2);
a ground electrode which is fixed to said metal shell (1), said ground electrode having a side face (4a) in which a width is smaller as advancing toward a tip end side, thereby forming a taper (4b); and
a discharge portion (52) which is bonded to said ground electrode by laser welding to attain a diameter of 0.8 mm or less and a height of 0.5 mm or more, a discharge gap (6) being formed between said discharge portion and said tip end portion (51) of said center electrode (3), wherein
said taper (4b) is formed before said discharge portion (52) is laser-welded to said side face (4a).

2. A method of producing a spark plug according to claim 1, wherein said discharge portion (52) is formed by conducting laser welding after a noble metal tip (52a) consisting primarily of a noble metal is placed to set a minimum distance between said tip, and said taper (4b) and a tip end face (4c) of said ground electrode (4) to be 0.1 mm or more and 0.8 mm or less.

3. A method of producing a spark plug according to claim 1 or 2, wherein said laser welding forms a molten bond (53) in which said noble metal tip and said ground electrode are melted together, with leaving an unmelted portion of a height (t) of 0.3 mm or more in said noble metal tip.

4. A method of producing a spark plug according to claim 3, wherein said molten bond (53) is formed to extend from said side face (4a) to said taper (4b), and has a curved shape which has a radius of curvature (R) in an edge formed by said side face (4a) and said taper (4b).

5. A spark plug having:
a center electrode (3);
an insulator (2) which covers a circumference of said center electrode (3) in a state where a tip end portion (51) of said center electrode (3) protrudes;
a metal shell (1) which holds said insulator (2);
a ground electrode which is fixed to said metal shell (1), said ground electrode having a side face (4a) in which a width is smaller as advancing toward a tip end side, thereby forming a taper (4b); and
a discharge portion (52) in which a noble metal tip (52a) is bonded to said ground electrode by laser welding to attain a diameter of 0.8 mm or less and a height of 0.5 mm or more, a discharge gap (6) being formed between said discharge portion and said tip end portion (51) of said center electrode (3), wherein
a molten bond (53) in which said noble metal tip (52a) and said ground electrode (4) are melted together is formed to extend from said side face (4a) to said taper (4b), said molten bond having a curved shape which has a radius of curvature (R) in an edge formed by said side face (4a) and said taper (4b).

6. A spark plug according to claim 5, wherein said noble metal tip (52a) is welded while an unmelted portion of said noble metal tip protrudes by 0.3 mm or more from said molten bond (53).

7. A spark plug according to claim 5 or 6, wherein said noble metal tip (52a) is made of one of a Pt—Ni alloy, a Pt—Rh alloy, a Pt—Rh—Ni alloy, an Ir—Pt alloy, an Ir—Rh alloy, an Ir—Pt—Rh—Ni alloy, and an Ir—Ru—Rh—Ni alloy.
